(19) United States
(12) Patent Application Publication
(10) Pub. No.: US 2017/0305636 A1
(43) Pub. Date: Oct. 26, 2017

(54) Formula-Mixing Bottle

(71) Applicant: Igor Michaylovich BERLINSKIY, Lukhovitsy, Moskovskaya obl (RU)

(72) Inventor: Igor Michaylovich BERLINSKIY, Lukhovitsy, Moskovskaya obl (RU)

(21) Appl. No.: 15/517,502

(22) PCT Filed: Sep. 25, 2015
(86) PCT No.: PCT/RU2015/000607

§ 371 Date: Apr. 6, 2017

(30) Foreign Application Priority Data
Oct. 23, 2014 (RU) 2014142610

(51) Int. Cl. B65D 81/32; A61J 11/04; A61J 9/00; B65D 25/56; B65D 23/04

(52) U.S. Cl. CPC B65D 81/3222; B65D 25/56; B65D 23/04; A61J 9/00; A61J 11/04; A61J 2205/50

(57) ABSTRACT

The proposed formula-mixing bottle relates to baby feeding vessels. It includes a first container with a bottom, a second container with a bottom, and a cap. The second container's bottom is formed by a closure member in the form of a raisable disk of a disk valve. The closure member has a screw shaft disposed on one side thereof, and the inside surface of the second container has a seal disposed thereon forming a seat for the disk of the closure member. The screw shaft is provided with a guide groove and is disposed inside a retaining sleeve having an arrester mounted in the opening thereof such as to be capable of interacting with the guide groove, and of restricting rotation of the screw shaft. The proposed bottle has a simplified structure as a result of the use of elements having less complex shapes.

### CROSS-REFERENCE TO RELATED APPLICATIONS

This application is a U.S. national stage application of an international application PCT/RU2015/000607 filed on 25 Sep. 2015, whose disclosure is incorporated herein in its entirety by reference, which international application claims priority of a Russian Federation patent application No. RU2014142610 filed on 23 Oct. 2014.

### FIELD OF THE INVENTION

The invention refers to vessels for feeding infants.

### BACKGROUND OF THE INVENTION

A bottle for preparing mixture of liquid and dry component is known, which comprises the first tank with a bottom, the second tank with a bottom which is formed with a slipping gear element of the valve, and a cap/the order of the UK 2489721, 2012.

The second tank of the known bottle is made using a slipping gear element, which complicates the shape of the parts that are coupled with it, which at the same time are extremely non-technological in manufacturing, and this leads to a rise in the cost of the product.

The invention is aimed at simplifying the bottle by using parts of less complex shapes.

To achieve the specified technical result a bottle for preparation of formula is offered, which comprises the first tank with a bottom, the second tank with a bottom, which is formed with a gear element of the valve, and a cap. The bottom of the second tank is formed with a gear element made in the shape of a disk of the lifting or rotary disk valve.

The gear element of the lifting valve is in the shape of a disk with a screw stem on one side of it, and on the inner surface of the second tank a seal is placed forming a seat for the disk of the gear element.

The screw stem is made with a guide chute and is set in the retaining bushing, in the opening of which is placed the rotation limiter of the screw stem of the disk of the gear element with the ability to interact with the guide chute.

The valve gear includes a rotary ring placed on the outer surface of the side wall of the second tank where the stopper of the position of the rotate ring is placed in the groove.

The screw stem of the disk is installed in the bushing, which is made with an internal thread in the hole and is connected to the rotary ring of the valve gear.

In an alternative construction the gear element of the lifting valve has a shape of a disk, which is configured to interact with the stopper of the valve gear ring and is set in with an ability to turn on an axis placed in the disk.

### DRAWINGS OF THE INVENTION

The invention is explained by the figures of the drawings, which show:

FIG. 1. A bottle for preparing mixture of powder and liquid

FIG. 2. The second tank with the lifting valve

FIG. 3. The connection node of the valve stem and retaining bushing

FIG. 4. The section A-A in FIG. 3

FIG. 5. The second tank with a rotary disk valve

FIG. 6. The section A-A in FIG. 5

### PREFERRED EMBODIMENTS OF THE INVENTION

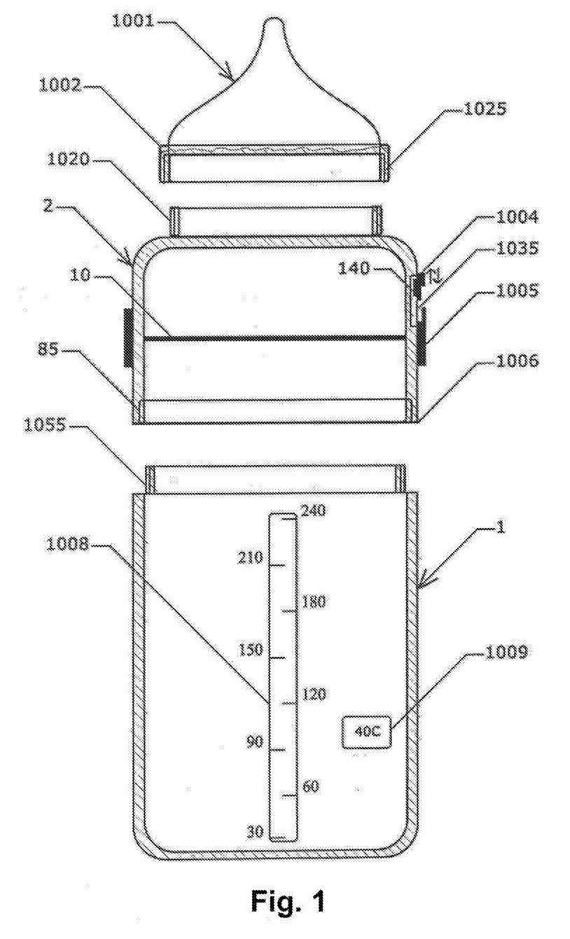

The bottle for preparing the mixture comprises (FIG. 1.) the first tank 1 with a bottom constructed with ability to be filled with a fluid medium-liquid, the second tank 2, which is constructed with ability to be filled with another medium—dry granular component, and a cap 1001 formed by a nipple, made with detachable joint possibility to the second tank 2 by a coupling nut 1002 with an internal thread.

The first tank 1 includes a side wall made with a cylindrical outer surface and a bottom. The first tank 1 has an area 1055 with external thread, which is located on the opposite side of the bottom. The liquid level indicator 1008 and the liquid temperature indicator 1009 are located on the outer surface of the side wall.

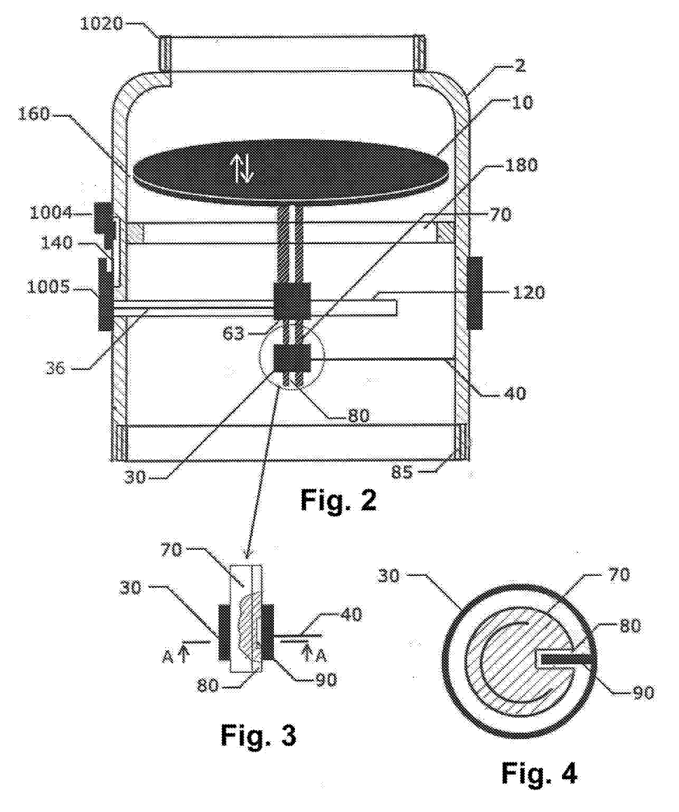

The second tank 2, in accordance with one alternative of construction, includes (FIG. 2.) a lifting valve, the body of which has a side wall with a cylindrical outer surface and forms the support of the seal 180 serving as a seat, and the gear element is in the shape of a disk.

On the side wall, on the one side, the internal thread area 85 is made, and the area with the outer thread 1020 is made on the opposite side.

The surface of the disk 10 from the side of the area with the outer thread 1020 forms the bottom of the second tank 2, and the screw stem 70 with the guide chute 80 is placed on its opposite surface.

Inside the tank 2 a transverse bar 40 with a retaining bushing 30 is located fixedly, in the hole of which, with the possibility of interacting with the guide groove of the screw stem, the rotation limiter 90 of the disk rotation 10 of the gear element is located (FIGS. 3,4).

The screw stem 70 of the disk 10 is set in the bushing 63 made with an internal thread in the hole and connected by a bar 36 with the rotary ring 1005 of the valve gear located on the outer surface of the side wall where in the longitudinal groove 140 the stopper 1004 of the rotary ring position 1005 is located. The angular translations of the rotary ring 1005, bushing 63 with internal thread, and the bar 36 are limited by a through groove 120 (in the shape of a non-closed circle—the angle of about 200°) on the side wall of the tank 2 through which the bar 36 passes.

Preparing the bottle for use.

The first tank 1 is filled with liquid, controlling the level by the indicator 1008. The second tank 2 with the closed valve is filled with a dry component.

The area 1055 with the external thread of the first tank 1 must be connected to the area 85 with the inside thread of the second tank 2, as well as must be made the connection of the area 1020 with the external thread of the second tank 2 and the area 1025 with the inside thread of the coupling nut 1002 for fixing the cap 1001.

The presence of the seal 180 in the composition of the lifting valve 10 of the tank 2 prevents the liquid contacting with the dry component in the bottle even in the upside-down position of the bottle during prolonged storage.

Preparing formula in the bottle.

On the second tank 2, the stopper 1004 is moved to the groove 140 of the side wall to a position, allowing the rotation of the rotary ring 1005 of the valve gear. Since the screw stem 70 of the disk 10 is set in the retaining sleeve 30 on the fixed transverse bar 40, the bar 36 rotates the bushing 63 with the internal thread under the action of the rotary ring 1005. This ensures the lifting of the disk 10 above the seal 180 by the screw stem 70. The lifting valve is open.

The inclination of the bottle ensures that the liquid flows from the tank 1 through the clearance 160 between the disk 10 and the side wall into the tank 2, where the blending with the powder of the dry component occurs. The formula is ready for use.

1. A bottle for preparing a mixture; said bottle comprising:
a first container;
a second container with a bottom, said second container is assembled with said first container; and
a cap assembled with said first container;
wherein: said bottom of the second container is formed by a closure member shaped as a raisable disk of a disk valve.

2. The bottle according to claim 1, wherein:
said second container further includes sidewalls having an inner surface; said second container encloses a seal secured on the inner surface of said sidewalls; said seal forms a seat for said closure member;
said closure member has a first side directed toward the cap, and a second side directed opposite to the cap; and
said bottle further comprises a screw shaft mounted on the second side of said closure member.

3. The bottle according to claim 2, wherein:
said second container further includes a retaining sleeve mounted inside thereof;
said screw shaft further includes a guide groove situated along thereof; the screw shaft is disposed inside an opening of the retaining sleeve; the retaining sleeve has an arrester disposed in the opening, such as to be capable of interacting with the guide groove, thereby restricting rotation of the screw shaft.

4. The bottle according to claim 3, wherein:
said sidewalls further have an outer surface;
said bottle further comprises a manual drive including:
a sidewall surface groove formed on the outer surface of said sidewalls and parallel to a central longitudinal axis of said container,
a sidewall through groove formed in said sidewalls across the central longitudinal axis of said container,
a turnable ring disposed on the outer surface of said sidewalls and capable of being turned within a limit set by the sidewall through groove, and
a stopper disposed in the sidewall surface groove, wherein said stopper fixes a position of said turnable ring.

5. The bottle according to claim 4, wherein:
said second container further includes a bushing having an inner threading; said bushing is coupled with the turnable ring; and
said screw shaft extends internally through the inner threading of said bushing.

6. (canceled)
